(19) United States
(12) Patent Application Publication
(10) Pub. No.: US 2009/0132308 A1
(43) Pub. Date: May 21, 2009

(54) Solution for Managed Personal Computing

(75) Inventors: Graylynne M. Randolph, Duvall, WA (US); William C. Stillwell, III, Kirkland, WA (US); James M. Hennessey, Kirkland, WA (US); Paul Harris, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 11/943,538

(22) Filed: Nov. 20, 2007

(51) Int. Cl. G06Q 30/00; G06Q 10/00

(52) U.S. Cl. 705/7; 705/1; 705/35

(57) ABSTRACT

Solutions for managed personal computing (SMPC) described herein involve providing multiple services to users in a bundled fashion. In one aspect, SMPC are implemented by a system including a service delivery platform configured to deliver a plurality of services provided by a plurality of entities to a client computer. Service logic running on the service delivery platform is provided to orchestrate a plurality of service adapters. The plurality of service adapters is configured to provide an interface between the service delivery platform and at least two servers associated with at least two of the entities. In this way, the service delivery platform provides a single interface for multiple different services.

### BACKGROUND

Communications providers, or Network Service Providers (NSPs), currently offer a variety of services to subscribers. Even so, NSPs are continually seeking new ideas and expanded service options to encourage the continuation of existing subscription agreements as well as the initiation of new ones. NSPs endeavor to provide all-inclusive packages for their subscribers in an effort to provide a one-stop shopping experience that retains subscribers' content with the available service options.

Many conventional NSP subscriptions provide the latest hardware linked to monthly service contracts. Such subscription agreements provide state-of-the-art equipment, such as the latest telephone or PDA model, at subsidized prices for use with services offered in the agreement. Other subscription agreements comprise telephone and personal digital assistant (PDA) subscriptions where subscribers “rent” cellular telephones and/or PDAs having the ability to gain access to the services chosen in the subscription. Still other subscription agreements include subscriptions for services only, where subscribers gain access to services utilizing their own equipment.

An expansion of services and hardware offered by communications providers could better serve subscribers and could enable NSPs to increase customer retention by offering a one-stop shopping experience for communications needs. An expansion of subscription offers may include personal computers with pre-configured broadband connections as well as services offered by a number of different entities.

### SUMMARY

This summary is provided to introduce simplified features and concepts of a solution for managed personal computing (SMPC) which is further described below in the Detailed Description. This summary is not intended to identify essential features of the claimed subject matter, nor is it intended for use in determining the scope of the claimed subject matter.

Solutions for managed personal computing described herein involve providing multiple services to users in a bundled fashion. In one aspect, SMPC are implemented by a system including a service delivery platform configured to deliver a plurality of services provided by a plurality of entities to a client computer. Service logic running on the service delivery platform is provided to orchestrate a plurality of service adapters. The plurality of service adapters is configured to provide an interface between the service delivery platform and at least two servers associated with at least two of the entities. In this way, the service delivery platform provides a single interface by which users may access and subscribe to multiple different services available from different entities.

In another aspect, a method is described in which a request is received from a client computer for a subscription to a plurality of services. At least two services offered by at least two different entities are configured. A service delivery platform is implemented, which manages the user request through a common interface facilitated by service-specific adapters, and the plurality of services subscribed to are delivered. These and other SMPC are described in more detail below.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts an illustrative system for implementing a solution for managed personal computing (SMPC).

FIG. 2 is a block diagram showing an illustrative operator server of the system of FIG. 1.

FIG. 3 is a block diagram showing an illustrative Operational Management WES adapter usable with the system of FIG. 1.

FIG. 4 is a block diagram showing an illustrative PC Security WES adapter usable with the system of FIG. 1.

FIG. 5 is a block diagram showing an illustrative Generic WES adapter usable with the system of FIG. 1.

FIG. 6 is a block diagram showing an illustrative Field Services WES adapter usable with the system of FIG. 1.

FIG. 7 is a flow diagram showing an illustrative method of implementing an SMPC.

### DETAILED DESCRIPTION

A solution for managed personal computing (SMPC) is described, in which implementations provide a subscription-based solution that leverages an existing service delivery platform to enable operators, such as network service providers (NSPs), independent software vendors (ISVs), or telecommunications providers, or other third party providers, to deliver services to subscribers via personal computers (PCs). While the SMPC are described hereafter in the context of NSPs, SMPC may be provided by any operator and are not limited to provision by NSPs. The services offered by the operators may include any desirable applications or services, such as, for example, operational management services, PC security services, PC maintenance services, field support services (e.g., diagnosis, installation, and maintenance), and billing services, to name a few. Several specific examples will be described in more detail below.

SMPC provide a platform where subscribers of an NSP may subscribe to any number of desired services. The SMPC platform enables NSPs to offer subscribers PCs packaged with services customized to their individual needs. The customized packages are available for an applicable fee, such as a monthly subscription fee, which varies depending upon the service packages chosen by the individual subscribers. The services offered by the NSPs via the SMPC platform may be provided by a number of different entities, or by one entity that offers all the desired services. The services may be general services available to the public, or custom-made services specific to subscribers' needs. The SMPC platform enables a PC subscriber to receive multiple services offered by multiple entities through an NSP subscription, without the added hassle, steps, or download requirements to receive the requested services.

The SMPC platform offers NSPs new opportunities to increase revenue and profits through subscription-based computing. The SMPC platform enables NSPs to deliver to PC subscribers their own services, such as e-mail, music, videos, pictures, web postings, and the like, in addition to services provided by other entities all via a single platform. As such, NSPs are able to supply their subscribers with a complete PC package subscription that includes a wide variety of services and features.

While features and concepts of the described systems and methods for SMPC can be implemented in any number of different environments, computing-based systems, television-based entertainment systems, and/or other configurations, implementations of SMPC are described in the context of the following illustrative systems and environments.

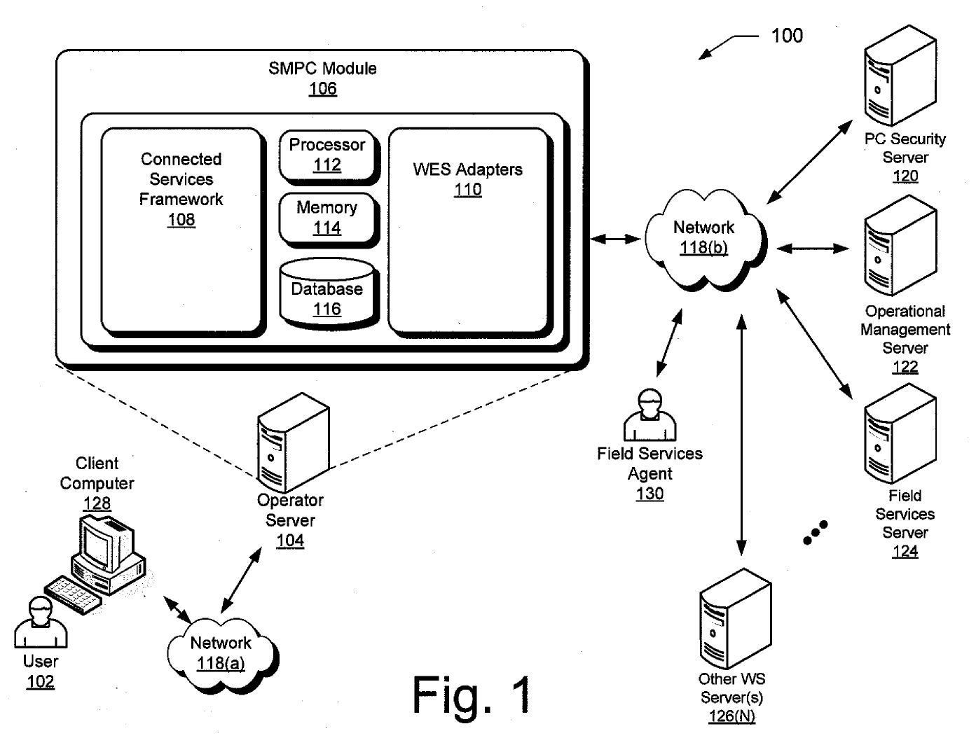

FIG. 1 is a schematic diagram of an illustrative system 100 for implementing SMPC. The illustrated configuration of the system 100 is only one example arrangement. Many arrangements of the illustrated components, or other similar components, are possible within the scope of the description herein. The system 100 is shown to include a user 102, an operator server 104, an SMPC module 106 located on the operator server 104, a service delivery platform in the form of a connected services framework 108 within the SMPC module 106, WES adapters 110, a processor 112, memory 114, and a database 116. The system 100 may further include networks 118(a) and 118(b), a PC security server 120, an operational management server 122, a field services server 124, and any number of other server(s) 126N). The user is shown to access the system 100 via a client computer 128.

The system 100 can enable a user 102 to access a plurality of services via a client computer 128, network connections 118(a) and 118(b), and operator server 104. The network connections 118(a) and 118(b) may be a public network, such as the Internet. While two network connections 118(a) and 118(b) are shown, any number of one or more public and/or private networks may be used. The internet data communications network can be implemented using any of a variety of different technologies, including wired and/or wireless communications technologies. Other types of communications networks may also be used for networks 118(a) and 118(b) in addition to or in place of the Internet, such as a local area network (LAN), wide area network (WAN), etc.

A user 102 may be a PC user who holds a subscription agreement as a subscriber with the operator to utilize specified services. In some implementations, the client computer 128 may be a PC owned by the operator and “leased” to the user 102 in a user-operator agreement employing subscription-based computing. In that case, the user-operator agreement may outline a group of subscriber-desired and elected services, which may be packaged onto the leased PC and are attainable to the user 102 via the client computer 128 and the operator server 104. The operator may be a network service provider (NSP) such as, for example, a telecommunications or cable television provider. The operator may maintain an operator server 104 accessible by a network 118(a) to its subscribers. The services offered via subscription agreements involving PCs packaged with services may be provided by the NSP or by the entity providing the packaged PC, if other than the NSP. An example of a PC subscription service is FlexGo™, offered by Microsoft Corporation of Redmond, Wash. FlexGo™ is based on a Windows®-based subscription offering by an NSP that includes Windows® XP or Windows Vista® bundled with an industry standard PC, applications, services, support, and/or connectivity. Other suppliers, components, and operating systems may also be used in providing PC subscription services.

The operator server 104 may comprise an SMPC module 106, which enables supports the SMPC platform. In one implementation, the SMPC module 106 includes a connected services framework 108 and Well Enabled Service (WES) adapters 110. The connected services framework 108 is a service delivery platform that enables operators to deliver services to subscribers. Examples of services that may be provided by the service delivery platform include, without limitation, web-based services (e.g., applications, programs, etc.), telecommunications services (e.g., wireless or wire line telephone services, voice over internet protocol, etc.), media services (e.g., cable television services, gaming services, etc.), data services (e.g., digital subscriber line services, cable Internet services, etc.), physical equipment rentals (computer rentals, hardware rentals, etc.), and the like. Service logic running on top of the connected service framework enables the adapters for different services to work together, facilitating the availability of a number of different services to the user 102.

The WES adapters 110 of the SMPC module 106 contain a defined set of interfaces which connect the connected services framework 108 with the servers (120-126(N)) of different entities via a network 118(b). Each service offered on a specific server, such as the PC security server 120 (where PC security is the service), has a service-specific WES adapter 110 within the SMPC module 106. The WES adapter 110 interfaces the specific services of the servers with the connected services framework 108 and enables the user 102 to receive and utilize any or all of the services offered on the servers (120-126(N)) of the different entities to which the user has subscribed.

Servers 120-126(N) represent the servers of entities offering services available to user 102. In the illustrative system 100, the PC security server 120, the operational management server 122, the field services server 124, and the other server(s) 126(N) may be servers of different entities or a common entity. In the illustrative examples described herein, the term entity is used to refer to a provider of a service. Each of the illustrated servers 120-126(N) offers one or more services available to the user 102 via an operator subscription. In system 100, examples of services offered by servers 120 and 122 include a PC security service and an operational management service, respectively. These services may be offered by two separate entities, as shown in system 100, or they may be offered by the same entity, i.e., from one or more servers of one entity. The other server(s) 126(N) represent services offered by any company or entity offering services available to a user 102 via an operator subscription. The number of other servers 126(N) and the number of services offered on the servers are limitless. When a subscriber elects services in a user-operator subscription agreement, a variety of possible entities providing the elected services may exist. By way of example, and for illustration purposes only, a user 102 may choose two services available on the servers of two different entities (e.g., one service from a cable provider and one from a PC security provider), five services available from the server of one entity (all five services from a telecommunications company), or 10 services available from 8 different entity servers (in which case at least some of the 10 services are available from the same entity).

The service options an operator utilizing the SMPC platform may offer its subscribing PC users are effectively unlimited. Through the use of the SMPC platform an operator may offer software as services to its subscribers, including operational management services such as, for example, Microsoft® FlexGo™, internet security services such as F-secure®, personal computer maintenance services such as PC Health, anti-virus, anti-spam, and anti-spyware services, firewall services, voice over internet protocol, telemetry, customer-driven support, or any other service desired by subscribers of the operator.

Following user 102 election of services in a user-operator subscription agreement, the elected services are configured by the SMPC platform prior to delivery to the user 102. Configuring the services includes interpreting the request from the user 102 and converting the request into service-compatible logic. A service delivery platform, such as the connected services framework 108, is implemented by translating the user 102 request and managing the request through a common interface facilitated by the WES adapters 110. This configuration ultimately enables the elected services to be delivered to the user 102 from the entity servers 120-126(N) via the connected services framework 108.

The SMPC module 106 may also include a processor 112, memory 114, and a database 116. Memory 114 may include software applications that are implemented as instructions and read and executed by the processor 112. The database 116 may include applications and data that are also read and executed by the processor 112.

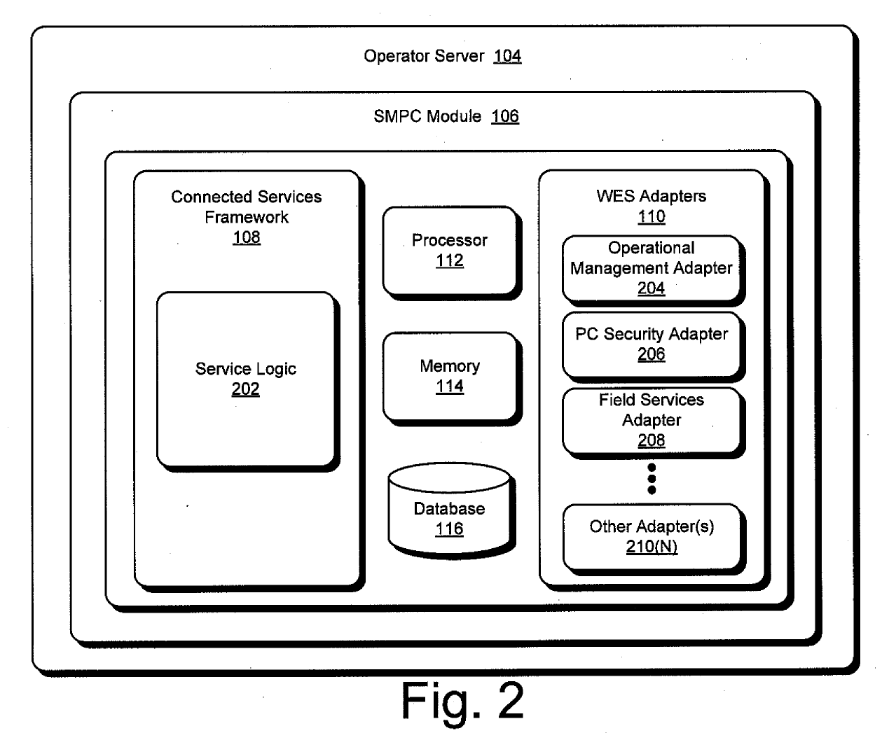

FIG. 2 is a block diagram showing an illustrative operator server 104 in which embodiments of SMPC can be implemented. For convenience of description, but not limitation, some items described previously are carried forward to FIG. 2, and denoted by the same reference numbers. The illustrated configuration of the operator server 104 is only one example arrangement. Other arrangements of the illustrated components are possible within the scope of the description herein.

The illustrative operator server 104 may include an SMPC module 106, which may contain a connected services framework 108, Well Enabled Service (WES) adapters 204-210(N), the processor 112, memory 114, and database 116. The connected services framework 108 may contain service logic 202, and the WES adapters may include an operational management adapter 204, a PC security adapter 206, a field services adapter 208, and one or more other adapters 210(N) that represent any number of other service-specific adapters. The other adapters 210 may be offered by the operator, the entities providing the operational management and PC security services, or other entities. As described for FIG. 1, memory 114 may include other software applications that are implemented as instructions and read and executed by the processor 112. The database 116 may also include applications and data that are read and executed by the processor 112.

The SMPC module 106 of the operator server 104 enables the employment of the SMPC platform by an operator. The operator may be a network service provider (NSP), such as, for example, a telecommunications provider or a cable television provider. The SMPC module 106, through the employment of the connected services framework 108 and the WES adapters 110, enables the operator to offer subscribers a variety of services from a number of different entities through its network.

The connected services framework 108 of the SMPC module 106 is a service delivery platform that enables operators to deliver services to subscribers. Service logic 202 running on top of the connected services framework 108 orchestrates the set of WES adapters 110, facilitating cooperation between WES adapters 110 that correspond to different services. This coordination of the WES adapters 110 by the service logic 202 contributes to the delivery of all requested services, regardless of the entity offering each service, to subscribers via the operator network.

The illustrative WES adapters 110 of SMPC module 106 include an operational management adapter 204, a PC security adapter 206, and a field services adapter 208, and one or more other adapters 210(N). The generic adapter 208(N) represents at least one and up to (N) number of adapters specific to services offered by various entities, including the entity(ies) providing the operational management and PC security services, an operator, an NSP, and/or other entities.

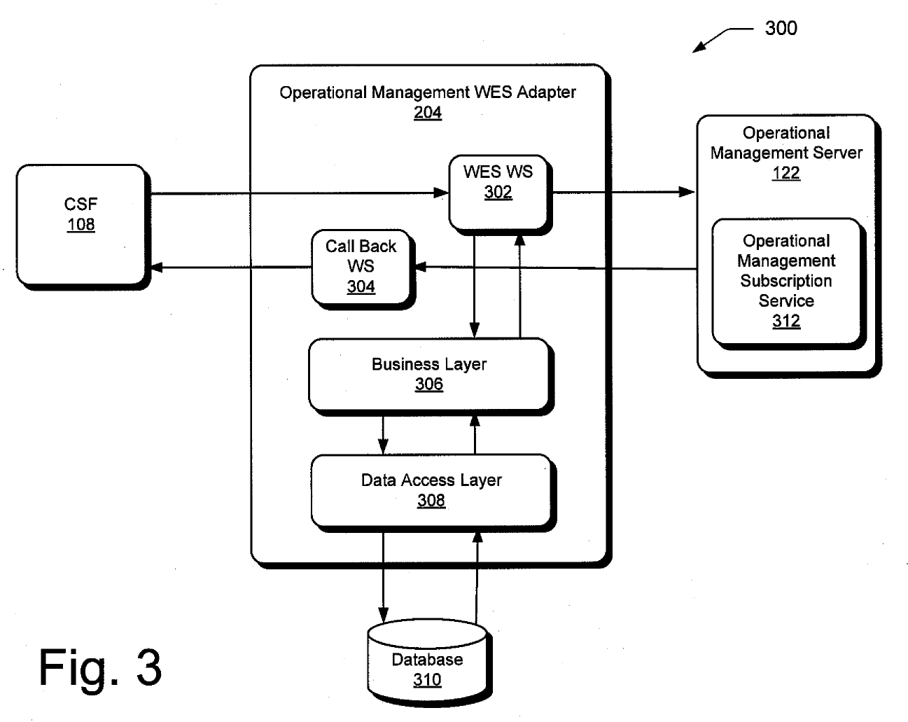

The WES adapters 110 are Well Enabled Service adapters that are connected-services-framework-aware, and which comply with WES concepts and specifications. The WES adapters 110 contain unique interfaces that enable operators to offer service applications to subscribers that are provided by entities other than the operator itself. Employing SMPC technology, an operator is enabled to coordinate and offer these additional services by utilizing information necessary to write adapters for specific services. The WES adapters 110 may be implemented by one or more application programming interfaces (APIs), the calls of which may be provided to third party developers. In this manner, WES adapters may be written for virtually any third party application. Once an adapter is written for a particular service, regardless of the entity that provides the actual service, the operator is able to offer this service to its subscribers via the SMPC platform. FIGS. 3-5 outline more specifically the creation of service-specific adapters by operators in order to provide particular services to subscribers.

FIG. 3 is a block diagram showing an illustrative system 300 including an operational management WES adapter 208 in which embodiments of SMPC can be implemented. For convenience of description, but not limitation, some items described previously are carried forward to FIG. 3 and denoted by the same reference numbers. The illustrated configuration of the illustrative system 300 is only one example arrangement. Other arrangements of the illustrated components are possible within the scope of the description herein.

The operational management WES adapter 208 may include a well enabled service (WES) web service (WS) 302, a call back web service (WS) 304, a business layer 306, a data access layer 308, and a database 310. The operational management WES adapter 204 facilitates communication with the operational management server 122, which may include an operational management subscription service 312.

The operational management WES adapter 204 is an adapter that interfaces with the connected services framework 108 and the operational management server 122, providing the operational management subscription service 314 to the user at the client computer 128. The interfaces of the operational management WES adapter 204 facilitate communication between the connected services framework 108 and the operational management server 122, allowing information exchange and the retrieval of the operational management service for use by a requesting user. The WES designation stands for a Well Enabled Service, which is a central services framework 108 classification that means the operational management WES adapter 204 is central-services-framework-aware and that it complies with the WES specification.

Generally, the operational management WES adapter 204 serves as a pass-through for the WS calls from an operational management service, such as, for example, Flex-Go™, offered by Microsoft Corporation of Redmond, Wash. Thus, the operational management WES adapter 204 receives requests from the CSF 108 and transforms them to operational management WS calls, and receives responses back from the operational management WS and updates the CSF 108. More specifically, as shown in FIG. 3, the CSF 108 (session) would call the WES WS 302, which forward the request to the business layer 306. Business layer 306 manages the requests on a per user basis, but checking the user's current subscription and payment status and other business rules/requirements to verify the appropriate action with subscription service 312. The data access layer 308 provides a normalized view of the database 310, which may be part of the SMPC 106, or may be separately provided by the operator. Data access layer 308 is responsible for abstracting the database information to transform the received call. Based on the response from the business layer 306, the WES WS 302 transforms the WS request to an operational management WS packet and sends the packet to the operational management subscription service 312. The operational management subscription service 312 responds by issuing a request to the callback WS adapter 304, which in turn calls the CSF 108. The specific transformations used will depend on the particular WS services being used.

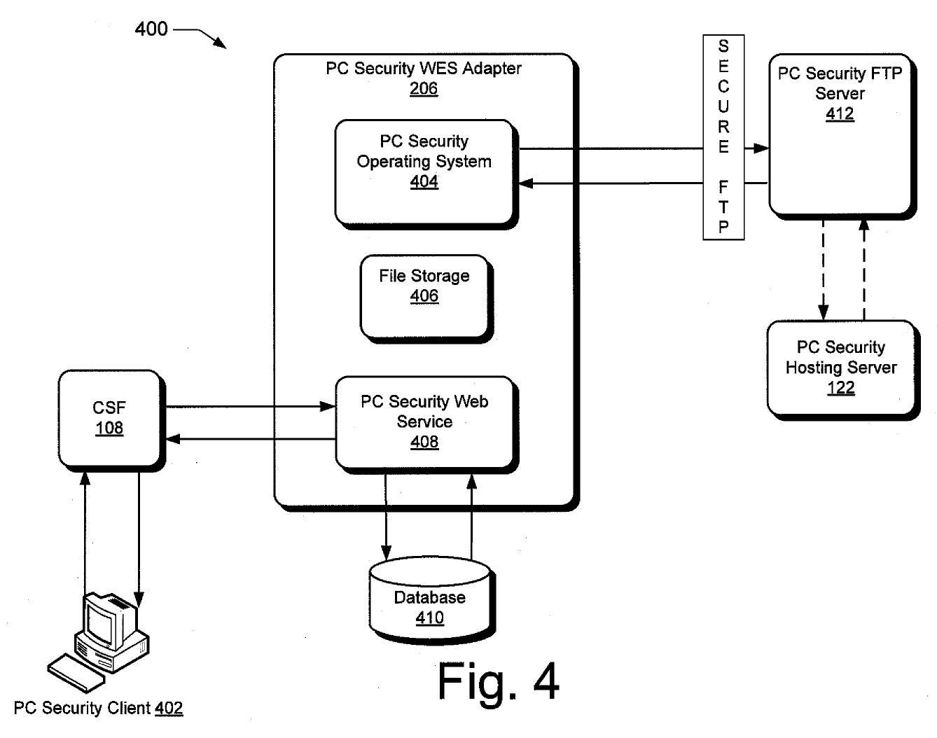

FIG. 4 is a block diagram of an illustrative system 400 including a PC security WES adapter 210 in which embodiments of SMPC can be implemented. For convenience of description, but not limitation, some items described previously are carried forward to FIG. 4 and denoted by the same reference numbers. The illustrated configuration of the illustrative system 400 is only one example arrangement. Other arrangements of the illustrated components are possible within the scope of the description herein.

The illustrative system 400 may include an SMPC module 106, a central services framework 108, a PC security client 402, a PC security WES adapter 210, a PC security FTP server 412, and a PC security hosting server 120. As shown in the illustrated example, the PC security WES adapter 210 may include a PC security operating system 404, file storage 406, PC security web service 408, and a database 410.

The PC security WES adapter 210 is an adapter that interfaces with the connected services framework 108 and the hosting server 414 providing the PC security service. The interfaces of the PC security WES adapter 210 facilitate communication between the connected services framework 108 and the hosting server 414, allowing information exchange and the retrieval of the PC security service for use by the PC security user on a PC 402. The WES designation stands for a Well Enabled Service, which is a central services framework 108 classification that means the PC security WES adapter 210 is central services framework 108—aware and that it complies with the WES specification. Alternatively, a user may take action independent of the SMPC module 106. For example, SMPC module 106 may make a change to PC security server 122. In the meantime, it is possible that the user's PC (i.e., PC security client) connects directly to the service 122 to receive the updated information.

For example, a PC user subscribes to an NSP subscription for a group of services. PC security is one of the services elected by the user in the subscription. The user does not subscribe directly with the provider of PC security, but rather signs up and receives the service through the NSP subscription. The PC security WES adapter 210 utilized by the NSP within the SMPC platform is written so that a user may receive a working version of the PC security service through the NSP network. After registering for a subscription that includes PC security, the user receives the PC security service with a set of keys that are not turned on but are valid in the user system. Once the user pays for the subscription, the set of keys are “turned on” and marked as “in use” by the PC security provider. Continued subscription payments ensure the availability of PC security to the user. If payments are late or if a user stops payment on the subscription, the NSP may turn off or inactivate the PC security keys through interaction with the PC security provider via the SMPC platform, thereby disabling some or all of the functionality of the services or the client computer 128 itself.

In the illustrated implementation, the PC security client 402 sends a request to the CSF 108 of the SMPC, which is forwarded to the PC security WES adapter 210. The PC security WES adapter receives the request at the PC security web service 408 and does a lookup in the database 410, looking for available keys. If there is an available key, the PC security web service 408 takes one and marks it as used. It then posts this information in a file in file storage 406. A simple service of the PC security operating system 404 then takes this file and uploads it to the PC security hosting server 120 via a secure shell file transfer protocol (FTP) and the PC security FTP server 412. Once the PC security server 120 gets the file, it authorizes the key and puts the accept/reject status in another file in the file storage 406 that the simple service then retrieves. The acceptance or rejection is marked in the database 410.

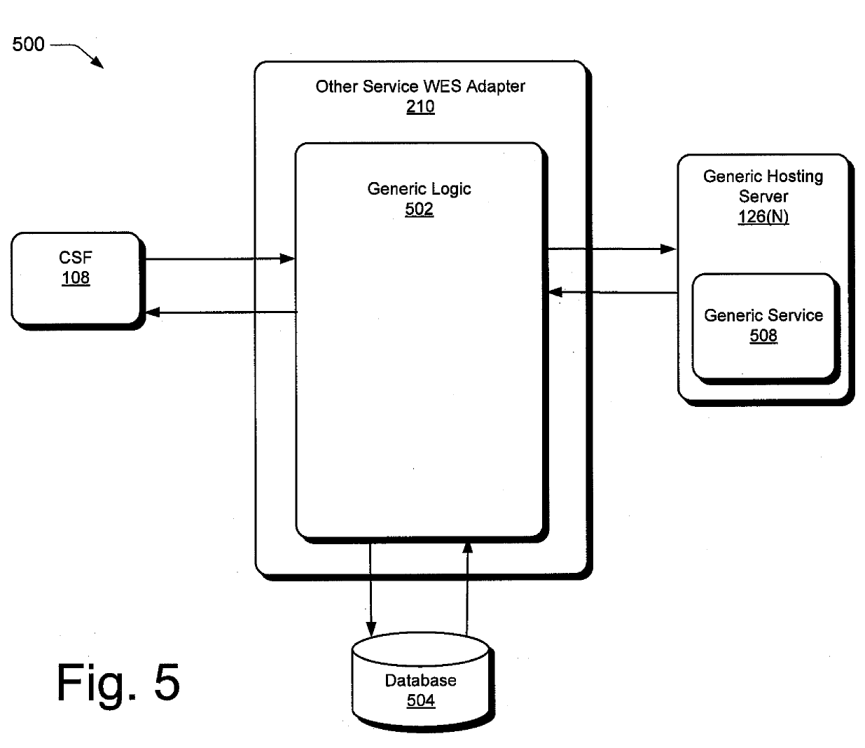

FIG. 5 is a block diagram of an illustrative system 500 including a generic WES adapter 212, in which embodiments of SMPC can be implemented. The generic WES adapter 212 is used to illustrate that adapters may be created for any other service desired by subscribers, and may be implemented as an adapter for any such service. For convenience of description, but not limitation, some items described previously are carried forward to FIG. 5 and denoted by the same reference numbers. The illustrated configuration of the illustrative system 500 is only one example arrangement. Other arrangements of the illustrated components are possible within the scope of the description herein.

The illustrative system 500 may include an SMPC module 106, a central services framework 108, a generic service WES adapter 212, an “other” hosting server 126 providing a generic service 506. The generic service WES adapter 212 may include generic logic 502 and a database 504.

The generic WES adapter 212 is an adapter that interfaces with the connected services framework 108 and one or more of the other servers 126(N) providing the generic service 506. A generic service may be offered by any software developer, including software developers other than those offering the SMPC (i.e., third party developers). The interfaces of the generic WES adapter 212 facilitate communication between the connected services framework 108 and the hosting server 506, allowing information exchange and the retrieval of the generic service for use by a user on a PC. The WES designation stands for a Well Enabled Service, which is a central services framework 108 classification that means the generic WES adapter 212 is central services framework 108—aware and that it complies with the WES specification. The generic WES adapter 212 may be implemented by one or more APIs, which transform calls from the CSF to generic WS packets for transmission to the generic service 506, and vice versa.

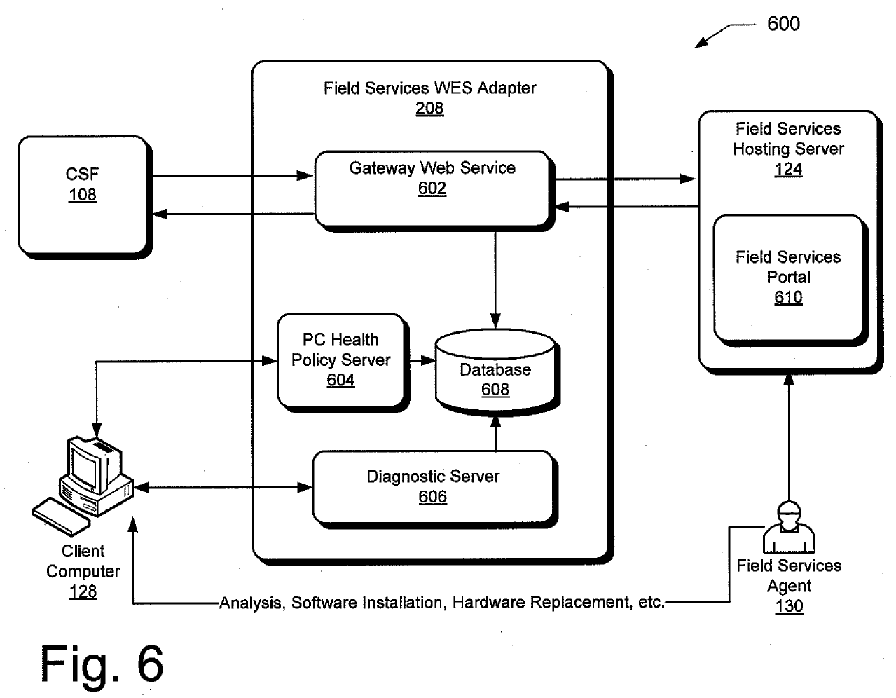

FIG. 6 is a block diagram of an illustrative field services framework 600 usable with the SMPC. For convenience of description, but not limitation, some items described previously are carried forward to FIG. 6 and denoted by the same reference numbers. The illustrated configuration of the illustrative system 600 is only one example arrangement. Other arrangements of the illustrated components are possible within the scope of the description herein.

Generally, the field services framework 600 provides a mechanism by which a field services agent 130 may monitor, analyze, and diagnose a subscriber's service experience. The field services framework 600 may also allow the field services agent 130 to install software and/or updates, to troubleshoot any issues, and schedule service for the subscription PC.

In the illustrated implementation, the field services framework 600 is implemented using a field services WES adapter 208, which includes a gateway web service 602, a PC health policy server 604, a diagnostic server 606, and a database 608. The field services WES adapter 208 enables the operator server 104 to integrate the CSF 108 with a field services portal 610 of the field services server 124. Accordingly, the CSF 108 is able to keep information regarding subscriptions and subscribers synchronized with the field services server 124 databases automatically.

In the implementation shown in FIG. 6, the PC health policy server 604 and diagnostic server 606 monitor the subscriber experience of client computer 128 (periodically, upon request, continuously, or according to any other desired monitoring scheme). Upon detection of an issue with the client computer 128, the field services adapter may institute provisioning of the client computer 128. Additionally or alternatively, the client computer may submit a request for provisioning. In either event, a provisioning request is sent to the CSF 108 identifying the subscriber WS information. The CSF 108 retrieves a service request tracking number from database 608 to assign to the provisioning request, and sends a response, containing the service request tracking number, to the field services WES adapter 208. Upon receipt of the provisioning request and the service request tracking number, the field services web adapter 208 transforms the provisioning request via the gateway web service 602 to a field services WS packet for transmission to the field services portal 610. The field services adapter 208 receives a response from the field services WS portal 610, which is relayed to the CSF 108 for display to the user of the client computer 128. In this manner, a field services agent 130 can diagnose, analyze, troubleshoot, install software, update software, change settings, or otherwise provision a subscriber client computer 128.

Methods of implementing SMPC will now be described with reference to illustrative FIGS. 1 and 2. The methods described herein may be implemented by computer-executable instructions stored on one or more computer-readable media. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

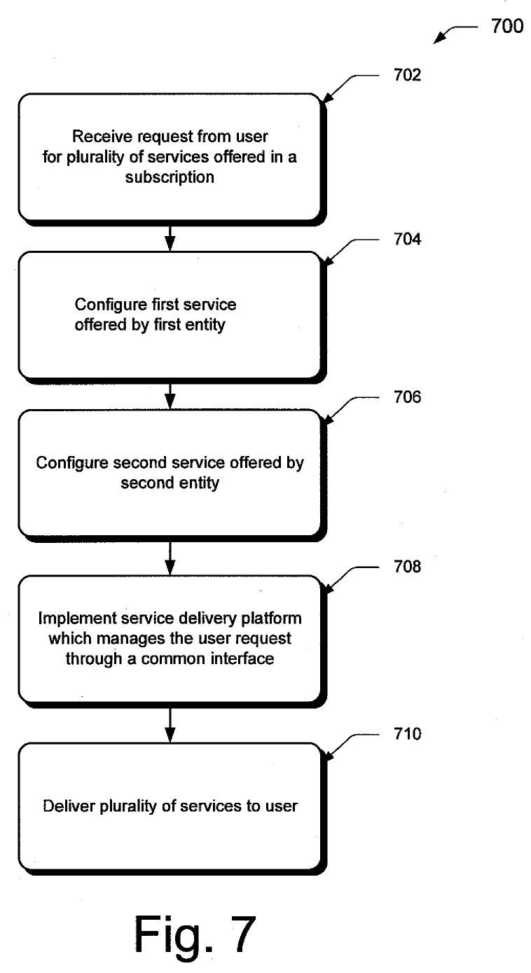

FIG. 7 is a flowchart of an illustrative method 700 of implementing a SMPC and is described with reference to the illustrative system 100 shown in FIG. 1 and the illustrative operator server 104 shown in FIG. 2. The order in which the method is described is not intended to be construed as a limitation, and any number of the described method blocks can be combined in any order, rearranged, or omitted to implement the method, or an alternate method. Furthermore, the method may be implemented by computer-executable instructions stored on one or more computer-readable media, and/or may be implemented in any suitable hardware, software, firmware, or combination thereof.

Block 702 represents receiving a request from a user for a plurality of services. For example, a user may be a subscriber to a subscription-based computing agreement with an operator for a PC packaged with services. The subscriber may request, for example, the use of eight services to be used on the PC, where the services and the PC are supplied by the operator for a monthly subscription fee paid by the subscriber.

Block 704 represents configuring a first service offered by a first entity. Continuing with the above example, in order to enable the use of the eight services to the subscriber, the operator configures a “first” service, a “second” service, and each subsequent service listed as available to the subscriber in the subscriber-operator agreement. The “first” service may be, for example, a PC maintenance service. The operator may configure the PC maintenance service by writing a service-specific adapter for the service, such as the WES adapters 110 of FIG. 1. The written adapter facilitates communication between a service delivery platform, such as a connected services framework 108, and the server of the entity providing the PC maintenance service application. The PC maintenance service may be offered by the operator or a third party entity, and may be available from a technical support agent via a field service framework, such as the field service server 124 of FIG. 1.

Block 706 represents configuring a second service offered by a second entity. Continuing with the above example, the operator configures the “second” service as described above for the “first” service, by writing a service-specific adapter for the “second” service. The operator may continue to write service-specific adapters for each of the services requested by the subscriber. Typically, the adapters will have been previously written for each service available to the subscriber. However, in some implementations, adapters may be written at the time they are requested by the user or thereafter. The services may be offered by one entity, or the eight services requested in this example may be offered by a number of different entities, such as up to eight different entities.

Block 708 represents implementing a service delivery platform which manages the user request through a common interface. For example, a service delivery platform, such as the connected services framework 108, is implemented by interpreting the request from the user and converting the request into service-compatible logic. The user request is translated and managed through a common interface which is facilitated by WES adapters. The service logic running on top of the connected services framework 108 may enable a number of service-specific WES adapters to collaborate to provide the subscriber the services requested. The service-specific adapters, such as the WES adapters 110 of FIG. 2, may include adapters for services provided by a number of different entities. For example, the operational management adapter 204, PC security adapter 206, and generic adapter 208 of may all interface with the servers of different entities, i.e., the services may each be offered by a different entity. The service logic 202 of the connected services framework 108 may enable each of these adapters to work together to provide the subscriber with services from different entities, without requiring the subscriber to do anything but pay a monthly subscription fee to the operator.

Block 710 represents delivering the plurality of services to the user. For example, the service delivery platform may deliver all eight requested services to the subscriber, for use on the PC of the subscriber-operator agreement. In relation to FIG. 1, the PC security service and the operational management service, in addition to any third party services, may be delivered to the user 102 on the personal computer 128 by the connected services framework 108. The connected services framework 108 receives the services via the network connection 118(b), and delivers the services to the user 102 via the network connection 118(a) between the operator server 104 and the PC 128 of the user 102. Alternatively, while the respective service (from one of servers 120-126(N) in may be provisioned through the SMPC module 106, the service itself may ultimately be delivered by/through the respective server (120-126(N)) directly to the client computer 128 via network 118(b), for example.

Although embodiments of SMPC have been described in language specific to structural features and/or methods, it is to be understood that the subject of the appended claims is not necessarily limited to the specific features or methods described. Rather, the specific features and methods are disclosed as illustrative implementations of SMPC.

What is claimed is:

1. A system, comprising:
a service delivery platform configured to deliver a plurality of services provided by a plurality of entities to a client computer; and
service logic running on the service delivery platform to orchestrate a plurality of adapters, wherein the plurality of adapters is configured to provide an interface between the service delivery platform and at least two servers associated with at least two of the entities.

2. The system of claim 1, wherein one of the adapters comprises a field services adapter configured to communicate with a field services framework, via which the client computer can be monitored and/or administered.

3. The system of claim 1, wherein each service comprises one of: provisioning services, billing services, security services, personal computer maintenance services, customer driven support services, account services, customer care services, identity services, or operational management services.

4. The system of claim 1, wherein each adapter includes a well enabled service (WES) to produce a web-enabled service accessible to the user via a network.

5. The system of claim 1, wherein the service delivery platform and adapters are configured as part of a management platform of a network service provider.

6. The system of claim 1, wherein the service delivery platform and the plurality of adapters provide the plurality of services offered by the plurality of entities on a single procurement site.

7. The system of claim 1, wherein each of the servers is configured to provide one or more services of an associated one of the plurality of entities.

8. A method, comprising:
receiving a request from a client computer for a subscription to a plurality of services;
configuring a first service offered by a first entity;
configuring a second service offered by a second entity, wherein the second entity is different than the first entity;
implementing a service delivery platform which manages the user request through a common interface facilitated by service-specific adapters and delivers the plurality of services subscribed to.

9. The method of claim 8, further comprising monitoring and/or administrating the client computer via the service delivery platform.

10. The method of claim 8, wherein implementing a service delivery platform comprises translating the request from the client computer for use by the service delivery platform.

11. The method of claim 8, wherein configuring the first service and configuring the second service comprises interpreting the request from the client computer and converting the request into service-compatible logic.

12. The method of claim 8, wherein the user is a subscriber to a network service provider and wherein the subscriber pays for the subscription to the plurality of services.

13. The method of claim 8, further comprising service logic running on top of the service delivery platform to enable the service-specific adapters to work together to facilitate delivery of the plurality of services to the client computer.

14. The method of claim 8, wherein a service-specific adapter comprises a web service that is service-delivery-platform-responsive and is a web version application programming interface (API) that makes the service corresponding to the adapter web aware.

15. One or more computer-readable media comprising computer-executable instructions that, when executed, perform acts comprising:
receiving a request from a client computer for subscription to a plurality of services;
configuring a first service offered by a first entity, wherein configuring the first service includes communication between a service delivery platform and a server of the first entity that offers the first service;
configuring a second service offered by a second entity, wherein configuring the second service includes communication between a service delivery platform and a server of the second entity that offers the second service; and
delivering the plurality of services to the user.

16. One or more computer-readable media as recited in claim 15, wherein the first entity and the second entity are two of a plurality of entities, and wherein each entity of the plurality of entities offers a different service.

17. One or more computer-readable media as recited in claim 15, wherein each service comprises one of: a provisioning service, a billing service, a security service, a personal computer maintenance service, a customer driven support service, an account service, a customer care service, an identity service, or an operational management service.

18. One or more computer-readable media as recited in claim 15, wherein each adapter is configured to provide an interface between the service delivery platform and a server associated with at least one of the entities.

19. One or more computer-readable media as recited in claim 15, wherein service logic running on the service delivery platform enables each adapter and corresponding service provided by each entity to work collectively with additional adapters and corresponding services.

20. One or more computer-readable media as recited in claim 15, further comprising instructions to monitor and/or administrating the client computer via the service delivery platform.
